(19) United States
(12) Patent Application Publication
(10) Pub. No.: US 2008/0003392 A1
(43) Pub. Date: Jan. 3, 2008

(54) Portable electronic device label sheet assembly

(75) Inventors: Alan Maule, Brea, CA (US); Jerry Hodsdon, Forest Dale, MA (US)

Correspondence Address: INGRASSIA FISHER & LORENZ, P.C., 7150 E. CAMELBACK, STE. 325, SCOTTSDALE, AZ, 85251, US

(73) Assignee: Avery Dennison Corporation

(21) Appl. No.: 11/479,917

(22) Filed: Jun. 30, 2006

(51) Int. Cl. B32B 33/00

(52) U.S. Cl. 428/40.1; 428/136

(57) ABSTRACT

Methods and apparatus are provided for a conformable label for a portable electronic device. The apparatus comprises a label sheet assembly formed of a facestock having a first side and an opposed second side. The facestock is formed of a conformable material that will adhere to contoured surfaces. The assembly further includes a release liner, covering the first side of the facestock. The facestock includes a plurality of cuts including a plurality of straight line cuts and a plurality of curved line cuts. The plurality of cuts may further include tie lines tying the label to another portion of the assembly. The plurality of cuts define at least one radiused cutout region in the conformable label and a perimeter of the conformable label for a portable electronic device.

### TECHNICAL FIELD

The present invention generally relates to labels and, more particularly, relates to adhesive and pressure-sensitive labels for cellular phones and other portable electronic devices.

### BACKGROUND

Labels or label-like coverings are commonly used to decorate or provide information on various objects and surfaces, including but not limited to, cellular equipment and other portable electronic devices. Many of these types of labels are preformed before being sold so a purchaser can readily adhere the labels to various surfaces. Labels can be preformed to include an adhesive, or alternatively can be preformed as pressure-sensitive labels.

Many cellular phones and similar electronic devices may have relatively complex contoured surfaces with compound curves. Even when relatively pliable materials are utilized to form the labels, conformability and/or adhesion to these relatively complex contours without wrinkling the material may be difficult. In a majority of instances, a portion of the label may not smoothly adhere to the device because of the device contours and limitations of the label material.

Another challenge in producing labels for cellular phones or similar electronic devices is that typically a rotary die cutting process is used to form the preformed labels. It has been found that rotary die cutting of relatively pliable materials, like thin cast vinyl, may cause problems. As an example, die cut pieces may tend to get stuck in the die cavities during die cutting.

Accordingly, it is desirable to provide labels that provide adhesion to contoured surfaces, including relatively complex contoured surfaces, such as those found on cellular telephones or other portable electronic devices. In addition, it is desirable to provide a method of manufacturing the labels that include a means for ensuring the labels can be preformed by rotary die cutting process. Furthermore, other desirable features and characteristics of the present invention will become apparent from the subsequent detailed description and the appended claims, taken in conjunction with the accompanying drawings and the foregoing technical field and background.

### BRIEF SUMMARY

There has now been developed a portable electronic device label sheet assembly that satisfies one or more of the above-noted deficiencies. In one embodiment, label sheet assembly comprises a facestock having a first side and an opposed second side, wherein the facestock is formed of a conformable material. The assembly further includes a release liner adhered to the second side of the facestock. The facestock includes a plurality of die cuts therein; the die cuts comprising a plurality of straight line die cuts and a plurality of curved line die cuts that define a perimeter of a conformable label for a portable electronic device.

In a further embodiment, still by way of example only, there is provided a portable electronic device label sheet assembly comprising a facestock having a first side and an opposed second side and wherein the facestock is comprised of a conformable material. The assembly further includes a single-layered leader portion adhered to at least one of the first side and the opposed second side of the facestock and a release liner adhered to the first side of the facestock. The facestock includes a plurality of die cuts comprising a plurality of straight line die cuts and a plurality of curved line die cuts that define at least one radiused cutout region, the facestock further including a plurality of tie lines that tie the conformable label to another area of the facestock.

In still a further embodiment, and still by way of example only, there is provided method of forming a portable electronic device label sheet assembly comprising the steps of providing a label sheet assembly including a facestock comprising a conformable material having a first side and an opposed second side and having a release liner adhered to at least a portion of the first side of the facestock. The labels are formed by die cutting a plurality of die cuts in the facestock to define a perimeter of a conformable label. The plurality of die cuts include a plurality of straight line die cuts and a plurality of curved line die cuts to define at least one arched cutout in the conformable label. The plurality of die cuts further define a plurality of tie lines in the facestock tying the conformable label to another area of the facestock.

Other independent features and advantages of the improved lip seal assembly will become apparent from the following detailed description, taken in conjunction with the accompanying drawings which illustrate, by way of example, the principles of the invention.

### BRIEF DESCRIPTION OF THE DRAWINGS

The present invention will hereinafter be described in conjunction with the following drawing figures, wherein like numerals denote like elements, and

FIG. 1 is a top view of a label sheet assembly, including a multilayered portion combined with a single-layered leader portion according to the present invention;

FIG. 2 is a side cross-section view of the label sheet assembly of FIG. 1;

FIG. 3 illustrates in top view another layout or configuration for a label sheet assembly including a plurality of labels according to the present invention; and

FIG. 4 illustrates in top view an additional exemplary label formed on a label sheet assembly according to the present invention.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

In the following description, a facestock is a sheet that may be formed from various materials including a pliable printable material or a pliable non-printable material that will readily conform and adhere to contoured surfaces, such as those found on cellular telephones. A multilayered laminated label sheet assembly at least initially includes at least two components: a release liner and the conformable facestock that may be described as pliable. The multilayered laminated label sheet assembly may additionally include an adhesive disposed between the release liner and the facestock. Each of the subsequently-described label sheet assemblies may additionally include a single-layered leader portion uniquely combined with a portion of the facestock to form a multilayered laminated label sheet assembly capable of being fed through a printer, such as a laser jet printer, ink jet printer, or the like. In addition, although the various embodiments are described as being die cut, it is anticipated that in an alternative embodiment a sign cutter may be used to form the designs.

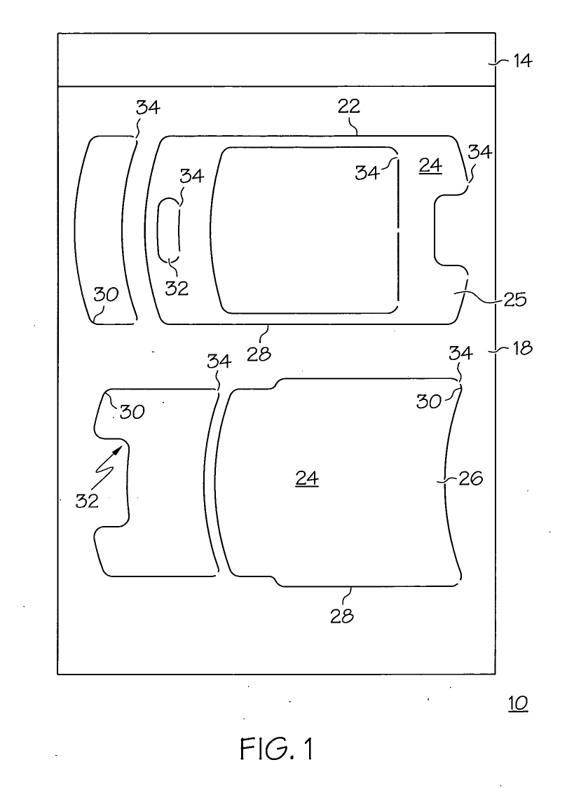

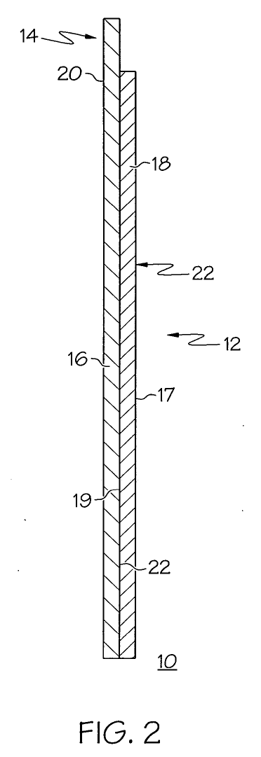

FIGS. 1-5 depict a plurality of embodiments of a label sheet assembly according to the present invention, showing various die cut configurations for portable electronic device labels, such as cellular telephone labels or portable media device labels. More specifically, referring to FIGS. 1 and 2, illustrated are a top view and a side cross-section view, respectively, of a label sheet assembly 10, including a multilayered portion 12 combined with a single-layered leader portion 14. As depicted in FIG. 2, the multilayered portion 12 includes a release liner 16 and a conformable facestock 18, having a first side 17 and an opposed second side 19. In this particular embodiment, conformable facestock 18 has a printable surface on first side 17. The single-layered leader portion 14 may be a portion of the release liner 16, or formed of paper, card stock, a transparent material, or some other material. When formed of a material other than the release liner 16, the single-layered leader portion 14 overlaps and is adhered to a portion of the conformable facestock 18 and abuts, or comes in close proximity to, the release liner 16. In this instance, it is preferable that the single-layered leader portion 14 abuts, but does not overlap the release liner 16.

Referring again to FIG. 1, the conformable facestock 18 includes a plurality of cuts 22 that extend through the conformable facestock 18 and define a perimeter of one or more labels 24, or portions of labels. The cuts 22 are typically formed using a die cut process, but in the alternative can be formed by a slicing process, such as done with a sign cutter. In the embodiment illustrated in FIG. 1, included are a multi-part front label 25 and a multi-part back label 26 for placement on the front and back of a cellular telephone, respectively. It should be understood that while a specific configuration of the labels 24 is depicted, any one of numerous label configurations is anticipated by this disclosure dependent upon end use. The sheet assembly 10 may also include other features such as printing, embossing, microperforations, and so forth.

In the illustrated embodiment, the plurality of cuts 22 include a plurality of straight line die cuts 28 and a plurality of curved line die cuts 30. The curved line die cuts 30 are formed as generally curved lines to form a plurality of radiused cutout portions 32. By forming the radiused cutout portions 32 in selective areas of the label 24, the label 24 will adhere smoothly to contoured surfaces. In addition, the curved line die cuts 30 are less susceptible to being peeled off during use of the device to which they are adhered. More specifically, the radiused cutout portions 32 allow the label 24 to conform to compound curves on various electronic devices. The radiused cutout portions 32 are designed to eliminate stress points where the label 24 could easily tear during removal, or create become wrinkled during application. The radiused cutout portions 32 work around the compound curves by venturing into the compound curve area only as far as the material will compress without inducing wrinkles in the label 24. By using a conformable material, such as a vinyl described below, label 24 may go part of the way into the compound curve section without generating wrinkles. This allows for greater overall coverage of the electronic device, while creating an overall shape that is visually appealing.

The plurality of cuts 22 are preferably formed using a rotary die cutter or cutters that are capable of cutting and scoring soft to semi-rigid material by forcing it between the blades on a cylindrical die and a hard cylindrical anvil or using a sign cutter as previously mentioned. In this particular embodiment, the conformable facestock 18 in which labels 24 are formed is preferably a pliable conformable material such as a pressure-sensitive vinyl material. The plurality of cuts 22 are uniquely created for each device based on obtaining a smooth fit of the label 24 on the device to which it is adhered, coverage of the device without interfering with the device function, and with consideration to good die design practices, such as no small angles and the use of radiused corners.

During the cutting and scoring process a plurality of tie lines 34 are created in the plurality of cuts 22 at selected leading edge locations. This avoids delamination of any of the die cut pieces from the release layer 16, resulting in the pieces becoming stuck in the die cavities during die cutting. Referring again to FIG. 1, illustrated are a plurality of tie lines 34 formed in the cuts 22. The tie lines 34 are generally areas in the die cut lines that are not cut during fabrication. The tie lines 34 enable the label 24 to remain partially attached to the surrounding matrix. More specifically, the tie lines 34 tie label 24 to another portion of label 24 or another portion of the label sheet assembly 10.

The tie lines 34 preferably have a thickness of between about 0.005 inches and about 0.040 inches. In this particular embodiment, tie lines 34 have a thickness of preferably about 0.020 inches. The tie lines 34 formed having this thickness offer sufficient strength to keep the die cut label pieces from lifting into the die while also breaking away cleanly from the matrix when a user applies the label 24.

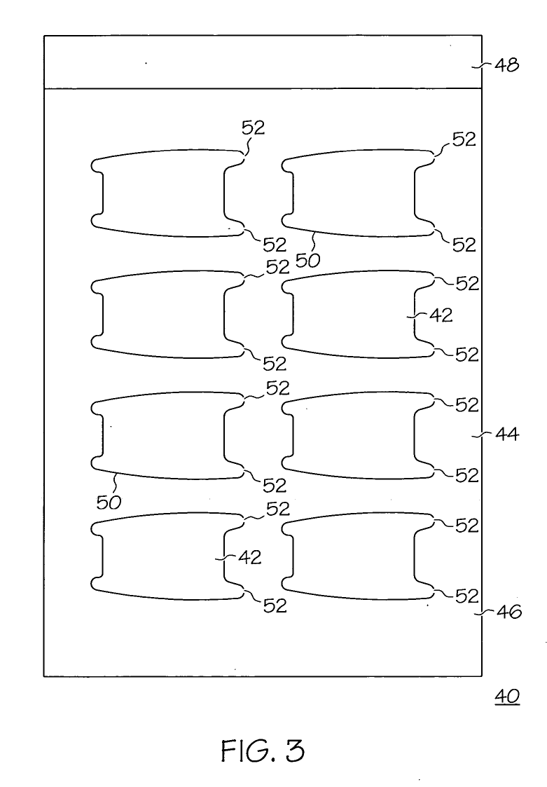

Referring now to FIG. 3, illustrated is another layout or configuration for a label sheet assembly 40 including a plurality of labels 42. Similar to the embodiment illustrated in FIGS. 1 and 2, the label sheet assembly 40 is formed of a multi-layered portion 44 that includes a release liner (not shown) and a conformable facestock 46. Facestock 46 may or may not include a printable surface. In this particular embodiment, the label sheet assembly 40 further includes a single-layered leader portion 48 which may be optional in another embodiment.

The label sheet assembly 40 includes the plurality of labels 42, formed generally similar to labels 24 of FIGS. 1 and 2. In this particular embodiment, eight identical labels 24 have been formed on the label sheet assembly 40 using die cutting processes to form a plurality of die cuts 50. The plurality of die cuts 50 define the perimeter of the labels 42 as previously described. In addition, a plurality of tie lines 52, such as those previously described are formed on at least one edge of each label 42.

Numerous other embodiments may be produced using a label sheet assembly that includes a multilayered portion combined with a single-layered leader portion, or a label sheet assembly that does not include a single-layered leader portion. The embodiments include but are not limited to label sheets with various numbers of labels formed thereon and in numerous configurations, dependent upon the device that the label will be adhered to.

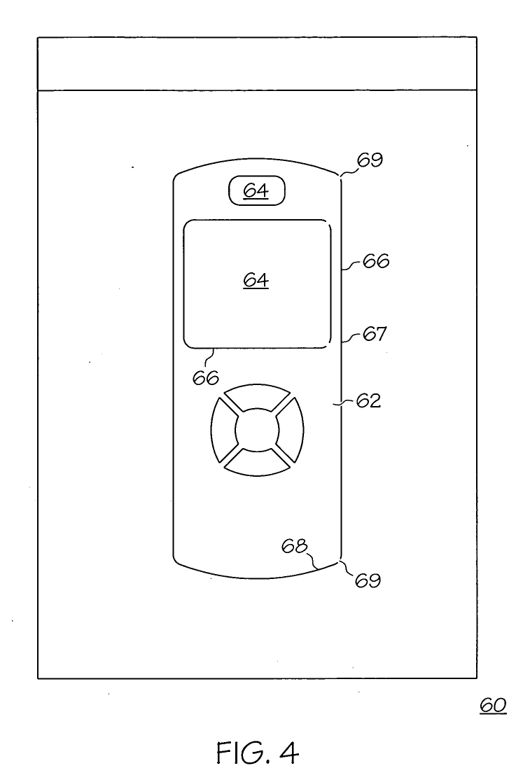

FIG. 4 depicts an additional exemplary label 62 formed on a label sheet assembly 60 and method of using the label 62. The label 62 illustrated in FIG. 4 is shaped and sized for use with a portable media player such as the Apple iPod®, that similar to a cellular telephone may include contoured surfaces. Other labels may be configured to be readily applied to any one of numerous devices including personal electronic devices such as MP3 players or PDA's

As depicted in FIG. 4, when removing the label 62 from the sheet 60 a plurality of die cut radiused cut out regions 64 are left on the sheet assembly 60. Alternatively, the die cut radiused cut out regions 64 may be removed with the label 62 and discarded before the label 62 is adhered to a portable media player.

The label 62 is formed in generally the same manner as label 24 of FIGS. 1 and 2. More specifically, label 62 is formed by a plurality of die cut lines 66 that include both straight line die cuts 67 and curved line die cuts 68. Label 62 is formed in a conformable or pliable material 61 so that it conforms to contoured surfaces of the portable media player. During fabrication, the plurality of straight line die cuts 66 are formed including a plurality of tie lines 69, as previously detailed.

Utilizing the above methods of sheet production, including die cutting or slicing with the use of ties, it is possible to form any number of sheet configurations to include conformable labels for adherence to portable electronic devices such as those described. In addition, this technology is not limited to desktop printable sheets or to sheets at all, as it could be utilized to produce fan folded or roll products with unique characteristics as well.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

1. A label sheet assembly, comprising:
a facestock having a first side and an opposed second side, the facestock comprising a conformable material; and
a release liner adhered to the second side of the facestock;
wherein the facestock includes a plurality of cuts therein extending from the first side to the second side, the plurality of cuts comprising a plurality of straight line cuts and a plurality of curved line cuts that define a perimeter of a conformable label for a portable electronic device and a facestock matrix, the plurality of cuts further defining a plurality of tie lines formed on a leading edge of the facestock tying the conformable label to at least a portion of the facestock matrix.

2. (canceled)

3. A label sheet assembly as claimed in claim 2, wherein at least one of the plurality of tie lines is defined by a portion of the perimeter of the label which is not cut.

4. A label sheet assembly as claimed in claim 1, further including at least one radiused cutout region.

5. A label sheet assembly as claimed in claim 1, wherein the conformable facestock material is a vinyl material.

6. The label sheet assembly as claimed in claim 1, wherein the release liner is adhered to the conformable facestock second side via a pressure-sensitive bond.

7. The label sheet assembly as claimed in claim 1, wherein the release liner is adhered to the conformable facestock second side via an adhesive material.

8. The label sheet assembly as claimed in claim 1, wherein the label sheet comprises a label for a single portable electronic device formed of a plurality of label portions, wherein each label portion is provided with at least one tie tying that label portion to another portion of the label sheet assembly.

9. The label sheet assembly as claimed in claim 1, wherein the label sheet comprises multiple labels on the face sheet and each label is provided with at least one tie tying the label to another portion of the facestock.

10. The label sheet assembly as claimed in claim 1, further including a single layered portion.

11. A label sheet assembly, comprising:
a facestock having a first side and an opposed second side, the facestock comprising a conformable material;
a single-layered leader portion adhered to at least one of the first side and the opposed second side of the facestock; and
a release liner adhered to the first side of the facestock;
wherein the facestock includes a plurality of die cuts extending from the first side to the second side comprising a plurality of straight line die cuts and a plurality of curved line die cuts that define a perimeter of a conformable label for a portable electronic device at least one radiused cutout region and a facestock matrix, the facestock further including a plurality of tie lines formed on a leading edge of the facestock tying the conformable label to another area of the facestock.

12. A label sheet assembly as claimed in claim 11, wherein at least one of the plurality of tie lines is defined by a portion of the perimeter of the label which is not die cut.

13. A label sheet assembly as claimed in claim 11, wherein the conformable facestock material is a vinyl material.

14. The label sheet assembly as claimed in claim 11, wherein the release liner is adhered to the conformable facestock second side via one of a pressure-sensitive bond or an adhesive material.

15. (canceled)

16. The label sheet assembly as claimed in claim 11, wherein the label sheet comprises a label for a single portable electronic device formed of a plurality of label portions, wherein each label portion is provided with at least one tie tying the label to another label portion.

17. The label sheet assembly as claimed in claim 11, wherein the label sheet comprises multiple labels on the face sheet and each label is provided with at least one tie tying the label to another portion of the face sheet.

18. A method of forming a label sheet assembly comprising the steps of:
providing a label sheet assembly including a facestock comprising a conformable material having a first side and an opposed second side and having a release liner adhered to at least a portion of the first side of the facestock; and
cutting a plurality of cuts in the facestock to define a perimeter of a conformable label, the plurality of cuts including a plurality of straight line cuts and a plurality of curved line cuts to define at least one radiused cutout region in the conformable label, the plurality of cuts further defining a plurality of tie lines on a leading edge of the facestock tying the conformable label to another area of the facestock.

19. A method of forming a label sheet assembly as claimed in claim 18, wherein the step of cutting includes roller die cutting.

20. A method of forming a label sheet assembly as claimed in claim 18, wherein the conformable label is formed of a stretchable pliable material that conforms to contoured surfaces when adhered thereto.
